(19) United States
(12) Patent Application Publication
(10) Pub. No.: US 2021/0129311 A1
(43) Pub. Date: May 6, 2021

(54) Universal Chisel Attachment

(71) Applicants: Adam Carter, Henderson, NV (US); Dave Hawks, Henderson, NV (US)

(72) Inventors: Adam Carter, Henderson, NV (US); Dave Hawks, Henderson, NV (US)

(21) Appl. No.: 17/086,142

(22) Filed: Oct. 30, 2020

Related U.S. Application Data
(60) Provisional application No. 62/928,979, filed on Oct. 31, 2019.

(51) Int. Cl. B25F 3/00; B25D 17/02; B25D 17/00; B25D 17/04

(52) U.S. Cl. CPC B25F 3/00; B25D 17/02; B25D 2250/111; B25D 17/04; B25D 2250/045; B25D 17/005

(57) ABSTRACT

A universal chisel attachment is an apparatus. A power tool, specifically an automatic drill, is converted to an automatic chiseler with the apparatus. The apparatus includes a socket adapter, a tubular housing, a chisel assembly, and a reciprocating mechanism. The socket adapter connects the apparatus to a power tool. The chisel assembly includes a chisel adapter and at least one chisel body. The tubular housing contains the connection between the socket adapter and the chisel adapter. The tubular housing also houses the reciprocating mechanism. The chisel adapter connects the at least one chisel body with the socket adapter. The at least one chisel body is the sharpened member of the apparatus that converts a power tool into an automatic chiseler. The hammering cam mechanism is used to convert rotational motion by socket adapter into back-and-forth linear motion by the chisel adapter.

The current application claims a priority to the U.S. provisional patent application Ser. No. 62/928,979 filed Oct. 31, 2019.

### FIELD OF THE INVENTION

The present invention generally relates to power tools. More specifically, the present invention is a universal chisel attachment for a cordless drill or impact tool.

### BACKGROUND OF THE INVENTION

An objective of the present invention is to provide a cordless drill or impact tool a mechanism and an adapter that converts rotational motion from the tool to an impacting chisel motion for a chisel member. The chisel attachment, preferably referred to as The Chissler, achieves the hammering chisel motion with the use of a power transmission mechanism. The present invention converts the mechanical rotation of drill or impact tool to a hammering motion transmitted through a chisel member. The present invention also provides various accessories which facilitate the operation of the present invention. A handle attachment is provided so the present invention does not rotate during operation. Multiple chisel members are provided which can be interchanged for different chiseling needs. Further, the present invention works in both forward and reverse direction of the drill or impact tool. In the preferred embodiment, the hammering motion of the chisel member is generated via cam teeth striking each other due to the rotation motion of the drill or impact tool. Furthermore, bronze bushings can be lubricated to maintain efficient operation.

### BRIEF DESCRIPTION OF THE DRAWINGS

FIG. 1 is a perspective view of a first embodiment the present invention.

FIG. 2 is a front side view of the first embodiment the present invention.

FIG. 3 is a cross-section view taken along line 3-3 in FIG. 2.

FIG. 4 is a perspective view of a second embodiment the present invention.

FIG. 5 is a front side view of the second embodiment the present invention.

FIG. 6 is a cross-section view taken along line 6-6 in FIG. 5.

FIG. 7 is a front side view of a tubular housing of the present invention.

FIG. 8 is a cross-section view taken along line 8-8 in FIG. 7.

FIG. 9 is an exploded view of the present invention.

### DETAIL DESCRIPTIONS OF THE INVENTION

All illustrations of the drawings are for the purpose of describing selected versions of the present invention and are not intended to limit the scope of the present invention.

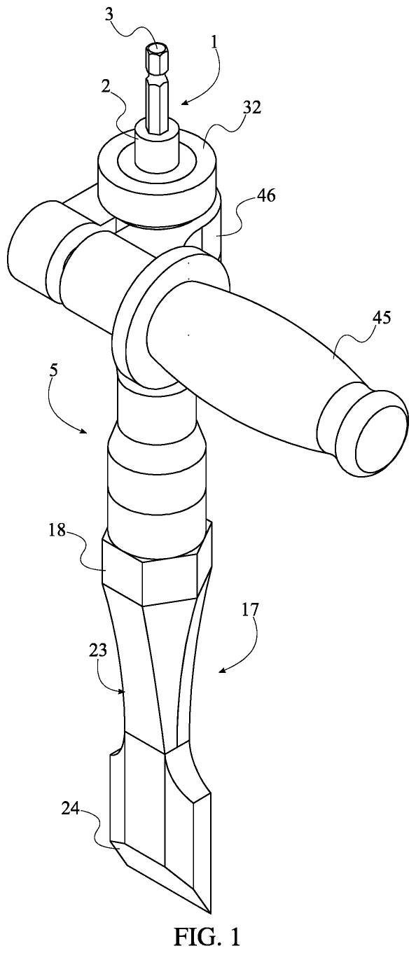

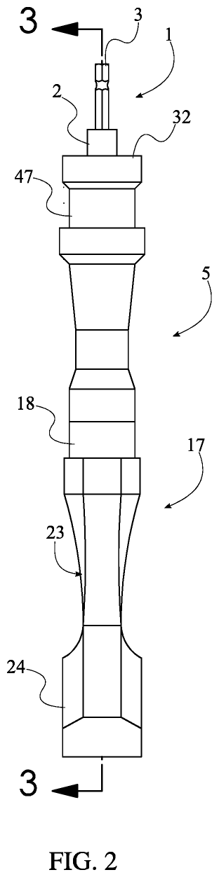

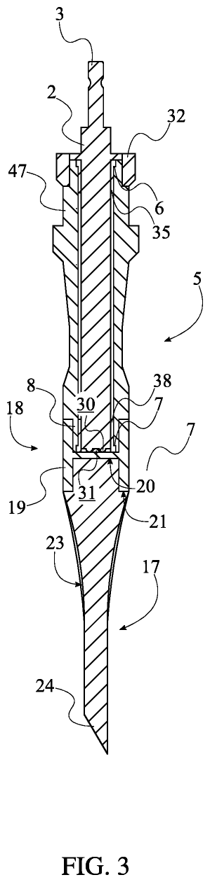

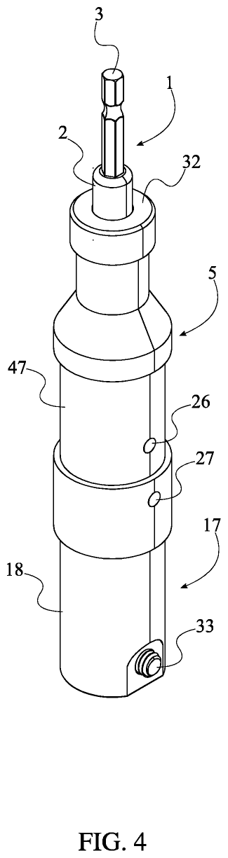

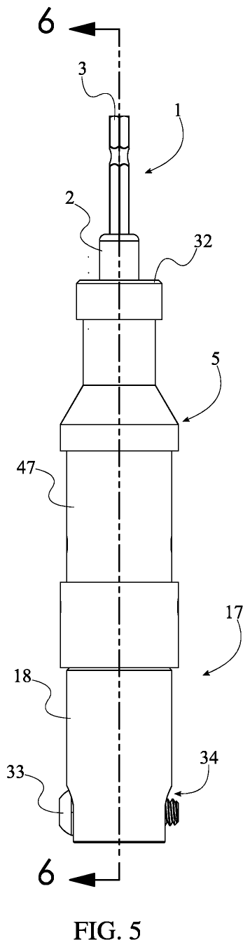

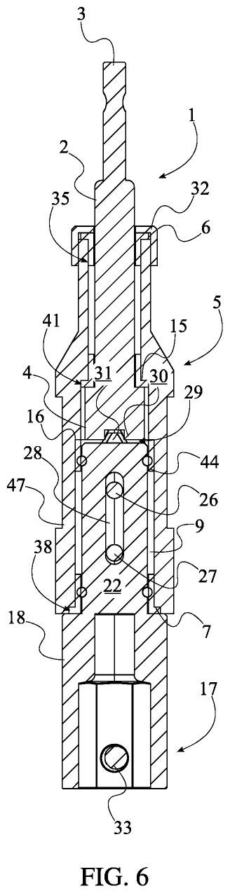

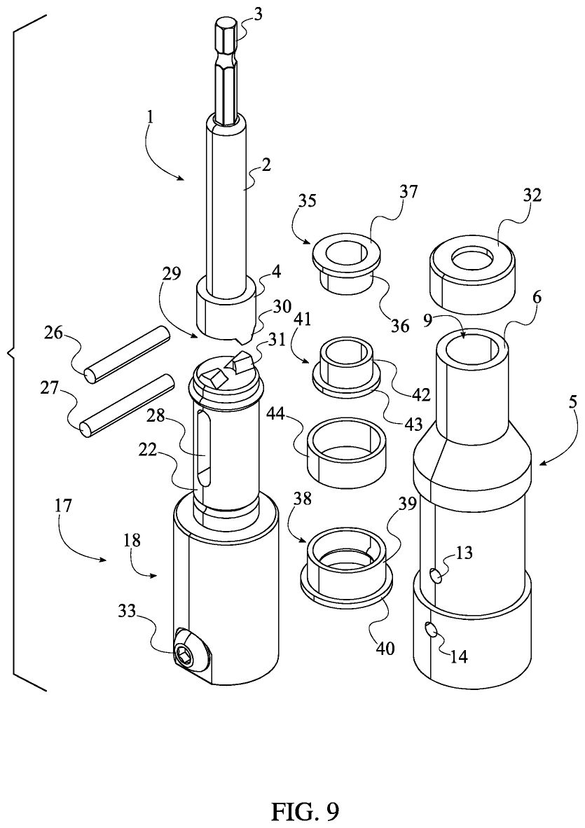

The present invention is a universal chisel attachment. The present invention enables a drill or impact tool to cut or shape materials with a hammering motion typically used with a chisel tool. The present invention serves as an adapter for a chisel attachment, furthering the functionality of a power tool or automatic drill. The present invention is compatible with a variety of power tools and automatic drills as the present invention may comprise a socket adapter 1, a tubular housing 5, a chisel assembly 17, and a hammering cam mechanism 29, seen in FIG. 1, FIG. 2, FIG. 3, FIG. 4, FIG. 5, FIG. 6, and FIG. 9. The socket adapter 1 connects the present invention with the chuck of a power tool. The socket adapter 1 comprises a shaft 2, a drill-engagement head 3, and a base 4. The shaft 2 rotates with the power tool. The drill-engagement head 3 secures the socket adapter 1 within the chuck. The base 4 engages the hammering cam mechanism 29. The tubular housing 5 connects the chisel assembly 17 with the socket adapter 1 and shields the hammering cam mechanism 29 from the surrounding environment. The chisel assembly 17 serves as the chisel attachment for the power tool. Moreover, the chisel assembly 17 comprises a chisel adapter 18 and at least one chisel body 23. The chisel adapter 18 connects the at least one chisel body 23 with the tubular housing 5, and the at least one chisel body 23 is the chisel member that hammers, cuts, and carves. The at least one chisel body 23 may comprise a plurality of chisel body with varying sharpness, widths, and lengths.

The overall arrangement of the aforementioned components converts the rotatory movement of a power tool to a linear movement. The socket adapter 1 is mounted within the chuck of the power tool as the drill-engagement head 3 is terminally connected to the shaft 2, seen in FIG. 3 and FIG. 6. Likewise, the socket adapter 1 is mounted within the tubular housing 5 as the base 4 is terminally connected to the shaft 2, opposite the drill-engagement head 3. More specifically, the shaft 2 is positioned into the tubular housing 5. The drill-engagement head 3 is externally positioned with the tubular housing 5, allowing the connection between the socket adapter 1 and the chuck to be uninhibited. The mechanism of a power tool is utilized as the shaft 2 is rotatably mounted with the tubular housing 5. The chisel adapter 18 is positioned adjacent with the tubular housing 5 and is slidably mounted with the tubular housing 5, thereby providing a continuous and uninhibited connection between the chisel assembly 17 and the tubular housing 5. Furthermore, the at least one chisel body 23 is positioned adjacent with the chisel adapter 18, opposite the tubular housing 5. The at least one chisel body 23 directly contacts a surface as the at least one chisel body 23 is removably attached into the chisel adapter 18. In order for the at least one chisel body 23 to strike the surface the base 4 is operatively coupled to the chisel adapter 18 by the hammering cam mechanism 29, wherein the hammering cam mechanism 29 is used to convert rotational motion by the base 4 into back-and-forth linear motion by the chisel adapter 18.

The preferred embodiment of the present invention may comprise an annular brace 32, seen in FIG. 1, FIG. 2, FIG. 3, FIG. 4, FIG. 5, FIG. 6, and FIG. 9. The annular brace 32 secures the socket adapter 1 within the tubular housing 5. The annular brace 32 engages with the socket adapter 1 as the annular brace 32 is positioned adjacent with the tubular housing 5, opposite the chisel adapter 18. The shaft 2 is positioned through the annular brace 32 and is rotatably mounted to the tubular housing 5 by the annular brace 32. This arrangement allows the shaft 2 to freely rotate while being further fastened within the tubular housing 5 with the annular brace 32.

In order for the chisel adapter 18 to connect with the at least one chisel body 23, the chisel adapter 18 may comprise a socket end 19, seen in FIG. 3. More specifically, the socket end 19 comprises an open adapter end 20 and a closed adapter end 21. The open adapter end 20 secures the at least one chisel body 23 within the socket end 19, and the closed adapter end 21 allows the at least one chisel body 23 to enter and exit the socket end 19. Furthermore, the at least one chisel body 23 may comprise a sharpened end 24 and an adapter end 25. The sharpened end 24 strikes a surface, and the adapter end 25 connects the at least one chisel body 23 with the chisel adapter 18. A chisel attachment is defined as the sharpened end 24 is positioned opposite the adapter end 25 about the at least one chisel body 23. The at least one chisel body 23 is connected with the tubular housing 5 as the closed adapter end 21 is positioned adjacent to the base 4. The opened adapter end 25 is positioned offset from the base 4, allowing the at least one chisel body 23 to be attached and detached from the chisel adapter 18. Moreover, the adapter end 25 traverses through the open adapter end 20 and is attached adjacent to the close adapter end 25. The chisel assembly 17 serves as a chisel attachment as the sharpened end 24 is externally positioned to the chisel adapter 18.

In order for the at least one chisel body 23 to be safely fastened within the socket end 19, the present invention preferably comprises at least one screw 33 and at least one bore 34, seen in FIG. 4, FIG. 5, FIG. 6, and FIG. 9. The at least one screw 33 connects the at least one chisel body 23 within the socket end 19, and the at least one bore 34 allows the at least one screw 33 to be mounted within the at least one chisel body 23 while preserving the structural integrity of the at least one chisel body 23. The at least one screw 33 freely traverses through both the chisel adapter 18 and the at least one chisel body 23 as the at least one bore 34 laterally traverses through the chisel adapter 18 and into the adapter end 25. More specifically, the at least one bore 34 is positioned in between the open adapter end 20 and the closed adapter end 21. The at least one screw 33 is threadably engaged within the at least one bore 34, safely fastening the at least one chisel body 23 within the chisel adapter 18. This engagement also allows the at least one chisel body 23 to be easily interchanged.

In order for the rotation of the socket adapter 1 to be translated into linear motion with the at least one chisel body 23, the hammering cam mechanism 29 may comprise a first plurality of slanted cam teeth 30 and a second plurality of slanted cam teeth 31, seen in FIG. 3, FIG. 6, and FIG. 9. The first plurality of cam teeth is radially connected into the base 4. Likewise, the second plurality of slanted cam teeth 31 is radially connected into the closed adapter end 21. This arrangement positions the first plurality of slanted cam teeth 30 adjacent with the second plurality of slanted cam teeth 31. The first plurality of slanted cam teeth 30 is intermeshed with the second plurality of slanted cam teeth 31, thereby providing the hammering cam mechanism 29 the necessary linkage to translate the rotary motion into linear motion.

In a first embodiment of the present invention, the tubular housing 5 may comprise a first rim 6, a second rim 7, and a lip 8, seen in FIG. 3. The first embodiment of the present invention provides a simple and secure connection wherein the tubular housing 5 is positioned into the chisel adapter 18. The first rim 6 allows the socket adapter 1 to traverse into the tubular housing 5. The second rim 7 allows the hammering cam mechanism 29 to engage with both the socket adapter 1 and the chisel adapter 18. The lip 8 allows for the linear movement of the chisel adapter 18 with the tubular housing 5 while preserving the connection between the chisel adapter 18 and the tubular housing 5. The tubular housing 5 connects the socket adapter 1 with the chisel adapter 18 as the first rim 6 is positioned opposite the second rim 7 along the tubular housing 5, and the shaft 2 is positioned through the first rim 6. The lip 8 is laterally integrated into the second rim 7 so that the chisel adapter 18 may engage with the lip 8. The at least one chisel body 23 is controlled with the linear motion from the hammering cam mechanism 29 as the second rim 7 is positioned into the socket end 19, and the socket end 19 is positioned opposite the at least one chisel body 23 about the chisel adapter 18. The lip 8 is slidably engaged within the socket end 19, thereby defining a hammering or striking movement for a power tool with the present invention.

The first embodiment of the present invention may further comprise a first bushing 35 and a second bushing 38, also seen in FIG. 3. Both the first bushing 35 and the second bushing 38 facilitate the rotation of the shaft 2 of the socket adapter 1 within the tubular housing 5. Furthermore, the first bushing 35 and the second bushing 38 reduces friction between the socket adapter 1 and the tubular housing 5. The first bushing 35 may comprise a first cylindrical member 36 and a first flange 37. The first cylindrical member 36 reduces or eliminates friction for the shaft 2. The first flange 37 secures the position of the first bushing 35 with the tubular housing 5. More specifically, the first bushing 35 is positioned adjacent the first rim 6. The first cylindrical member 36 is positioned into the tubular housing 5, thereby positioning the first bushing 35 between the shaft 2 and the tubular housing 5. The first flange 37 is pressed against the first rim 6 to prevent the first bushing 35 from sliding into the tubular housing 5. The shaft 2 is rotatably engaged within the first cylindrical member 36, eliminating any friction between the shaft 2 and the tubular housing 5 near the first rim 6. Similarly, the second bushing 38 may comprise a second cylindrical member 39 and a second flange 40. The second cylindrical member 39 reduces or eliminates friction for the base 4. The second flange 40 secures the position of the second bushing 38 with the tubular housing 5. More specifically, the second bushing 38 is positioned adjacent the second rim 7. The second cylindrical member 39 is positioned into the tubular housing 5, thereby positioning the second bushing 38 between the base 4 and the tubular housing 5. The second flange 40 is pressed against the second rim 7 to prevent the second bushing 38 from sliding into the tubular housing 5. The shaft 2 is rotatably engaged within the second cylindrical member 39, eliminating any friction between the base 4 and the tubular housing 5 near the second rim 7.

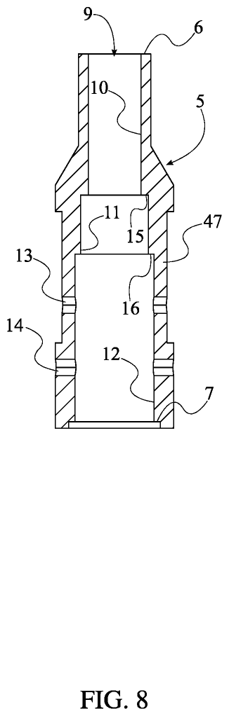

In a second embodiment of the present invention, the tubular housing 5 may comprise a first rim 6, a second rim 7, a main channel 9, a first groove 10, a second groove 11, and a third groove 12, seen in FIG. 8. The second embodiment of the present invention provides a more secure connection between the chisel adapter 18 and the tubular housing 5 in order to account for a more powerful power tool or the solidity of a surface. In the second embodiment of the present invention, the chisel adapter 18 also may comprise a plug 22. The main channel 9 positions both the socket adapter 1 and the plug 22 within the tubular housing 5. The first groove 10 and the second groove 11 accommodate the socket adapter 1. More specifically, the first groove 10 surrounds the shaft 2, and the second groove 11 surrounds the base 4. The third groove 12 accommodates the plug 22. The first groove 10 preferably comprises a diameter that is smaller than that of the second groove 11. Furthermore, the second groove 11 preferably comprises a diameter that is smaller than of the third groove 12. This arrangement counteracts the rotational force of the power tool with the shaft 2, and consequently the linear force of the chisel assembly 17, such that the connection between the socket adapter 1 and the chisel adapter 18 is further secured, as well as the connection between the socket adapter 1 and the power tool. Similar with the first embodiment of the present invention, the first rim 6 is positioned opposite the second rim 7 along the tubular housing 5. More specifically, the main channel 9 traverses from the first rim 6 to the second rim 7. The first groove 10, the second groove 11, and the third groove 12 are integrated into the main channel 9 as the socket adapter 1 and the chisel adapter 18 engage with one another through the hammering cam mechanism 29. The first groove 10 is positioned adjacent with the first rim 6. The third groove 12 is positioned adjacent with the second rim 7. The second groove 11 is positioned in between the first groove 10 and the third groove 12. In order to connect the at least one chisel body 23 with the tubular housing 5 in the second embodiment of the present invention, the plug 22 is positioned opposite the at least one chisel body 23 about the chisel adapter 18. The shaft 2 is positioned within the first groove 10 and the second groove 11, further securing the shaft 2 within tubular housing 5. The plug 22 is positioned within the third groove 12, further securing the chisel adapter 18 within the tubular housing 5.

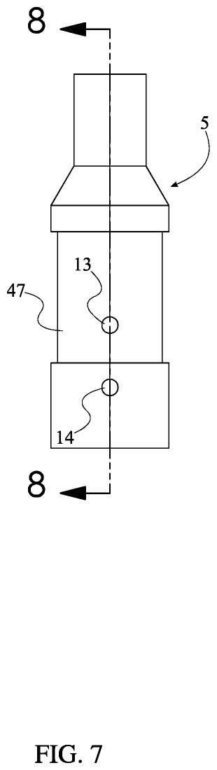

The connection between the chisel adapter 18 and the tubular housing 5 is further secured in the second embodiment of the present invention as the tubular housing 5 of the second embodiment of the present invention may comprise a first hole 13 and a second hole 14, seen in FIG. 7, FIG. 8, and FIG. 9. Furthermore, the chisel assembly 17 may further comprise a first pin 26, a second pin 27, and an elongated slot 28. The first hole 13 and the second hole 14 allow the first pin 26 and the second pin 27, respectively, to traverse through the tubular housing 5 while preserving the structural integrity of the tubular housing 5. The first pin 26 and the second pin 27 fasten the plug 22 within the tubular housing 5. The elongated slot 28 allows the plug 22 to freely slide within the tubular housing 5 while connected with the first pin 26 and the second pin 27. The first hole 13 and the second hole 14 laterally traverse through the tubular housing 5, allowing the first pin 26 and the second pin 27 to freely enter into and exit out of the tubular housing 5. The elongated slot 28 is positioned along the plug 22 to account for the linear motion of the chisel adapter 18. The elongated slot 28 also traverses through the plug 22 so that a continuous path is defined for the first pin 26 and the second pin 27 through the plug 22 and, consequently, the entire tubular housing 5. The first pin 26 and the second pin 27 are positioned through the elongated slot 28 in order to engage and secure the plug 22. More specifically, the first pin 26 is fixed within the first hole 13, and the second pin 27 is fixed within the second hold. The linear motion of the chisel adapter 18 remains uninhibited by the first pin 26 and the second pin 27 as the first pin 26 and the second pin 27 are slidably engaged within the elongated slot 28.

The second embodiment of the present invention may further comprise a first bushing 35, a second bushing 38, a third bushing 41, and a cylindrical spacer 44, seen in FIG. 6 and FIG. 9. The first bushing 35 may comprise a first cylindrical member 36 and a first flange 37. The first cylindrical member 36 reduces or eliminates friction for the shaft 2. The first flange 37 secures the position of the first bushing 35 with the tubular housing 5. More specifically, the first bushing 35 is positioned adjacent the first rim 6. The first cylindrical member 36 is positioned within the main channel 9, thereby positioning the first bushing 35 between the shaft 2 and the main channel 9. The first flange 37 is pressed against the first rim 6 to prevent the first bushing 35 from sliding into the first groove 10. The shaft 2 is rotatably engaged within the first cylindrical member 36, eliminating any friction between the shaft 2 and the tubular housing 5 near the first rim 6. Similarly, the second bushing 38 may comprise a second cylindrical member 39 and a second flange 40. The second cylindrical member 39 reduces or eliminates friction for the plug 22. The second flange 40 secures the position of the second bushing 38 with the tubular housing 5. The second bushing 38 is positioned adjacent the second rim 7. The second cylindrical member 39 is positioned into the tubular housing 5, thereby positioning the second bushing 38 between the plug 22 and the tubular housing 5. The second flange 40 is pressed against the second rim 7, to prevent the second bushing 38 from sliding into the third groove 12. The cylindrical spacer 39 is pressed against the second ledge 40. The plug 22 is rotatably engaged within the second cylindrical member 39, eliminating any friction between the plug 22 and the tubular housing 5 near the second rim 7.

In the second embodiment of the present invention, the base 4 of the socket adapter 1 is further secured within the main channel 9 as the tubular housing 5 may further comprise a first ledge 15, seen in FIG. 6 and FIG. 9. The first ledge 15 serves as a stopper for the base 4 of the socket adapter 1 within the main channel 9. The third bushing 41 facilitates the rotation of the shaft 2 around the first ledge 15. Similar with the first bushing 35 and the second bushing 38, the third bushing 41 may comprise a third cylindrical member 42 and a third flange 43, also seen in FIG. 6 and FIG. 9. The third cylindrical member 42 reduces or eliminates friction for the shaft 2, and the third flange 43 secures the position of the third bushing 41 between the shaft 2 and the base 4. In order to reduce or eliminate friction around the edge between the shaft 2 and the base 4 of the socket adapter 1 within the main channel 9, the first ledge 15 is integrated into the channel and is positioned in between the first groove 10 and the second groove 11. More specifically, the third cylindrical member 42 is positioned into the first groove 10, positioning the third bushing 41 in between the shaft 2 and the main channel 9. The third flange 43 is pressed against the first ledge 15 to prevent the third bushing 41 from sliding within the first groove 10. The shaft 2 is rotatably engaged within the third cylindrical member 42, eliminating any friction between the shaft 2 and the main channel 9 around the first ledge 15.

Furthermore, in the second embodiment of the present invention, the plug 22 of the chisel adapter 18 is further secured within the main channel 9 as the tubular housing 5 may further comprise a second ledge 16, seen in FIG. 6 and FIG. 9. The second ledge 16 accommodates the cylindrical spacer 44 that facilitates the linear motion of the plug 22 against the base 4 of the socket adapter 1. More specifically, the cylindrical spacer 44 serves as a bushing. The second ledge 16 is integrated into the main channel 9 and positioned in between the second groove 11 and the third groove 12 so that the cylindrical spacer 44 may be positioned around the plug 22, specifically adjacent with the base 4 of the socket adapter 1. Moreover, the cylindrical spacer 44 is positioned into the second groove 11. The plug 22 is rotatably engaged within the cylindrical spacer 44, eliminating any friction between plug 22 and the main channel 9 around the second ledge 16.

Alternate embodiments of the present invention may further comprise a handle 45, a clamp 46, and a handle-receiving groove 47, seen in FIG. 1, FIG. 2, FIG. 3, FIG. 4, FIG. 5, FIG. 6, FIG. 7, FIG. 8, and FIG. 9. The handle 45 enables the user to better control and maneuver the present invention while engaged with a power tool. The clamp 46 allows the handle 45 to be removably attached around the tubular body. The handle-receiving groove 47 keeps the position of the clamp 46, and consequently the position of the handle 45, fixed along the tubular housing 5. The handle-receiving groove 47 is laterally integrated into the tubular housing 5 so that the position of the clamp 46 remains stationary along the tubular housing 5 at all times. The handle 45 is fixed adjacent with the clamp 46 and is positioned perpendicular to the tubular housing 5 so that the present invention is easily grasped by the user with the handle 45. The clamp 46 is engaged around the handle-receiving groove 47 in order to fasten the handle 45 with the tubular housing 5.

Although the invention has been explained in relation to its preferred embodiment, it is to be understood that many other possible modifications and variations can be made without departing from the spirit and scope of the invention as hereinafter claimed.

What is claimed is:

1. A universal chisel attachment comprises:
a socket adapter;
a tubular housing;
a chisel assembly;
a hammering cam mechanism;
the socket adapter comprises a shaft, a drill-engagement head, and a base;
the chisel assembly comprises a chisel adapter and at least one chisel body;
the drill-engagement head being terminally connected to the shaft;
the base being terminally connected to the shaft, opposite the drill-engagement head;
the shaft being positioned into the tubular housing;
the drill-engagement head being externally positioned with the tubular housing;
the shaft being rotatably mounted with the tubular housing;
the chisel adapter being positioned adjacent with the tubular housing;
the chisel adapter being slidably mounted with the tubular housing;
the at least one chisel body being positioned adjacent with the chisel adapter, opposite the tubular housing;
the at least one chisel body being removably attached into the chisel adapter; and,
the base being operatively coupled to the chisel adapter by the hammering cam mechanism, wherein the hammering cam mechanism is used to convert rotational motion by the base into back-and-forth linear motion by the chisel adapter.

2. The universal chisel attachment as claimed in claim 1 comprises:
an annular brace;
the annular brace being positioned adjacent with the tubular housing, opposite the chisel adapter;
the shaft being positioned through the annular brace; and,
the shaft being rotatably mounted to the tubular housing by the annular brace.

3. The universal chisel attachment as claimed in claim 1 comprises:
the chisel adapter comprises a socket end;
the socket end comprises an open adapter end and a closed adapter end;
the at least one chisel body comprises a sharpened end and an adapter end;
the sharpened end being positioned opposite the adapter end about the at least one chisel body;
the closed adapter end being positioned adjacent to the base;
the open adapted end being positioned offset from the base;
the adapter end traversing through the open adapter end;
the adapter end being attached adjacent to the closed adapter end; and,
the sharpened end being externally positioned to the chisel adapter.

4. The universal chisel attachment as claimed in claim 3 comprises:
at least one screw;
at least one bore;
the at least one bore laterally traversing through the chisel adapter and into the adapter end;
the at least one bore being positioned in between the open adapter end and the closed adapter end; and,
the at least one screw being threadedly engaged within the at least one bore.

5. The universal chisel attachment as claimed in claim 3 comprises:
the hammering cam mechanism comprises a first plurality of slanted cam teeth and a second plurality of slanted cam teeth;
the first plurality of slanted cam teeth being radially connected into the base;
the second plurality of slanted cam teeth being radially connected into the closed adapter end; and,
the first plurality of slanted cam teeth being intermeshed with the second plurality of slanted cam teeth.

6. The universal chisel attachment as claimed in claim 1 comprises:
the tubular housing comprises a first rim, a second rim, and a lip;
the chisel adapter comprises a socket end;
the first rim being positioned opposite the second rim along the tubular housing;
the shaft being positioned through the first rim;
the lip being laterally integrated into the second rim;
the second rim being positioned into the socket end;
the socket end being positioned opposite the at least one chisel body about the chisel adapter; and,
the lip being slidably engaged within the socket end.

7. The universal chisel attachment as claimed in claim 6 comprises:
a first bushing;
the first bushing comprises a first cylindrical member and a first flange;
the first bushing being positioned adjacent the first rim;
the first cylindrical member being positioned into the tubular housing;
the first flange being pressed against the first rim; and,
the shaft being rotatably engaged within the cylindrical member.

8. The universal chisel attachment as claimed in claim 6 comprises:
a second bushing;
the second bushing comprises a second cylindrical member and a second flange;
the second bushing being positioned adjacent the second rim;
the second cylindrical member being positioned into the tubular housing;
the second flange being pressed against the second rim by the closed receptacle; and,
the shaft being rotatably engaged within the cylindrical member.

9. The universal chisel attachment as claimed in claim 1 comprises:
the tubular housing comprises a first rim, a second rim, a main channel, a first groove, a second groove, and a third groove;
the chisel adapter comprises a plug;
the first rim being positioned opposite the second rim along the tubular housing;
the main channel traversing from the first rim to the second rim;
the first groove, the second groove, and the third groove being integrated into the main channel;
the first groove being positioned adjacent with the first rim;
the third groove being positioned adjacent with the second rim;
the second groove being positioned in between the first groove and the third groove;
the plug being positioned opposite the at least one chisel body about the chisel adapter;
the shaft being positioned within the first groove and the second groove; and,
the plug being positioned within third groove.

10. The universal chisel attachment as claimed in claim 9 comprises:
the tubular housing comprises a first hole and a second hole;
the chisel assembly further comprises a first pin, a second pin, and an elongated slot;
the first hole and the second hole laterally traversing through the tubular housing;
the elongated slot being positioned along the plug;
the elongated slot traversing through the plug;
the first pin and the second pin being positioned through the elongated slot;
the first pin being fixed within the first hole;
the second pin being fixed within the second hole; and,
the first pin and the second pin being slidably engaged within the elongated slot.

11. The universal chisel attachment as claimed in claim 9 comprises:
a first bushing;
the first bushing comprises a first cylindrical member and a first flange;
the first bushing being positioned adjacent the first rim;
the first cylindrical member being positioned within the main channel;
the first flange being pressed against the first rim; and,
the shaft being rotatably engaged within the first cylindrical member.

12. The universal chisel attachment as claimed in claim 9 comprises:
a second bushing;
the second bushing comprises a second cylindrical member and a second flange;
the second bushing being positioned adjacent the second rim;
the second cylindrical member being positioned into the tubular housing;
the second flange being pressed against the second rim; and,
the plug being rotatably engaged within the second cylindrical member.

13. The universal chisel attachment as claimed in claim 9 comprises:
a third bushing;
the tubular housing further comprises a first ledge;
the third bushing comprises a third cylindrical member and a third flange;
the first ledge being integrated into the main channel;
the first ledge being positioned in between the first groove and the second groove;
the third cylindrical member being positioned into the first groove;
the third flange being pressed against the first ledge; and,
the shaft being rotatably engaged within the third cylindrical member.

14. The universal chisel attachment as claimed in claim 9 comprises:
a cylindrical spacer;
the tubular housing further comprises a second ledge;
the second ledge being integrated into the main channel;
the second ledge being positioned in between the second groove and the third groove;
the cylindrical spacer being positioned into the second groove;
the cylindrical spacer being pressed against the second ledge; and,
the plug being rotatably engaged within the cylindrical spacer.

15. The universal chisel attachment as claimed in claim 1 comprises:
a handle;
a clamp;
a handle-receiving groove;
the handle-receiving groove being laterally integrated into the tubular housing;
the handle being fixed adjacent with the clamp;
the handle being positioned perpendicular to the tubular housing; and,
the clamp being engaged around the handle-receiving groove.

16. A universal chisel attachment comprises:
a socket adapter;
a tubular housing;
a chisel assembly;
a hammering cam mechanism;
a handle;
a clamp;
a handle-receiving groove;
the socket adapter comprises a shaft, a drill-engagement head, and a base;
the chisel assembly comprises a chisel adapter and at least one chisel body;
the drill-engagement head being terminally connected to the shaft;
the base being terminally connected to the shaft, opposite the drill-engagement head;
the shaft being positioned into the tubular housing;
the drill-engagement head being externally positioned with the tubular housing;
the shaft being rotatably mounted with the tubular housing;
the chisel adapter being positioned adjacent with the tubular housing;
the chisel adapter being slidably mounted with the tubular housing;
the at least one chisel body being positioned adjacent with the chisel adapter, opposite the tubular housing;
the at least one chisel body being removably attached into the chisel adapter;
the base being operatively coupled to the chisel adapter by the hammering cam mechanism, wherein the hammering cam mechanism is used to convert rotational motion by the base into back-and-forth linear motion by the chisel adapter;
the handle-receiving groove being laterally integrated into the tubular housing;
the handle being fixed adjacent with the clamp;
the handle being positioned perpendicular to the tubular housing; and,
the clamp being engaged around the handle-receiving groove.

17. The universal chisel attachment as claimed in claim 16 comprises:
an annular brace;
the annular brace being positioned adjacent with the tubular housing, opposite the chisel adapter;
the shaft being positioned through the annular brace; and,
the shaft being rotatably mounted to the tubular housing by the annular brace.

18. The universal chisel attachment as claimed in claim 16 comprises:
at least one screw;
at least one bore;
the chisel adapter comprises a socket end;
the socket end comprises an open adapter end and a closed adapter end;
the at least one chisel body comprises a sharpened end and an adapter end;
the hammering cam mechanism comprises a first plurality of slanted cam teeth and a second plurality of slanted cam teeth;
the sharpened end being positioned opposite the adapter end about the at least one chisel body;
the closed adapter end being positioned adjacent to the base;
the open adapted end being positioned offset from the base;
the adapter end traversing through the open adapter end;
the adapter end being attached adjacent to the closed adapter end;
the sharpened end being externally positioned to the chisel adapter;
the at least one bore laterally traversing through the chisel adapter and into the adapter end;
the at least one bore being positioned in between the open adapter end and the closed adapter end;
the at least one screw being threadedly engaged within the at least one bore;
the first plurality of slanted cam teeth being radially connected into the base;
the second plurality of slanted cam teeth being radially connected into the closed adapter end; and,
the first plurality of slanted cam teeth being intermeshed with the second plurality of slanted cam teeth.

19. The universal chisel attachment as claimed in claim 16 comprises:
a first bushing;
a second bushing;
the first bushing comprises a first cylindrical member and a first flange;
the second bushing comprises a second cylindrical member and a second flange;
the tubular housing comprises a first rim, a second rim, and a lip;
the chisel adapter comprises a socket end;
the first rim being positioned opposite the second rim along the tubular housing;
the shaft being positioned through the first rim;
the lip being laterally integrated into the second rim;
the second rim being positioned into the socket end;
the socket end being positioned opposite the at least one chisel body about the chisel adapter;
the lip being slidably engaged within the socket end;
the first bushing being positioned adjacent the first rim;
the first cylindrical member being positioned into the tubular housing;
the first flange being pressed against the first rim;
the shaft being rotatably engaged within the cylindrical member;
the second bushing being positioned adjacent the second rim;
the second cylindrical member being positioned into the tubular housing;
the second flange being pressed against the second rim by the closed receptacle; and,
the shaft being rotatably engaged within the cylindrical member.

20. The universal chisel attachment as claimed in claim 16 comprises:
a first bushing;
a second bushing;
a third bushing;
a cylindrical spacer;
the tubular housing comprises a first rim, a second rim, a main channel, a first groove, a second groove, a third groove, a first hole, a second hole, a first ledge, and a second ledge;
the chisel assembly further comprises a first pin, a second pin, and an elongated slot;
the chisel adapter comprises a plug;
the first bushing comprises a first cylindrical member and a first flange;
the second bushing comprises a second cylindrical member and a second flange;
the third bushing comprises a third cylindrical member and a third flange;
the first rim being positioned opposite the second rim along the tubular housing;
the main channel traversing from the first rim to the second rim;
the first groove, the second groove, and the third groove being integrated into the main channel;
the first groove being positioned adjacent with the first rim;
the third groove being positioned adjacent with the second rim;
the second groove being positioned in between the first groove and the third groove;
the plug being positioned opposite the at least one chisel body about the chisel adapter;
the shaft being positioned within the first groove and the second groove;
the plug being positioned within third groove;
the first hole and the second hole laterally traversing through the tubular housing;
the elongated slot being positioned along the plug;
the elongated slot traversing through the plug;
the first pin and the second pin being positioned through the elongated slot;
the first pin being fixed within the first hole;
the second pin being fixed within the second hole;
the first pin and the second pin being slidably engaged within the elongated slot;
the first bushing being positioned adjacent the first rim;
the first cylindrical member being positioned within the main channel;
the flange being pressed against the first rim;
the shaft being rotatably engaged within the first cylindrical member;
the second bushing being positioned adjacent the second rim;
the second cylindrical member being positioned into the tubular housing;
the second flange being pressed against the second rim;
the plug being rotatably engaged within the second cylindrical member;
the first ledge being integrated into the main channel;
the first ledge being positioned in between the first groove and the second groove;
the third cylindrical member being positioned into the first groove;
the third flange being pressed against the first ledge; and,
the shaft being rotatably engaged within the third cylindrical member.
the second ledge being integrated into the main channel;
the second ledge being positioned in between the second groove and the third groove;
the cylindrical spacer being positioned into the second groove;
the cylindrical spacer is pressed against the second ledge; and,
the plug being rotatably engaged within the cylindrical spacer.
